(19) United States
(12) Patent Application Publication
(10) Pub. No.: US 2016/0009135 A1
(43) Pub. Date: Jan. 14, 2016

(54) Vehicle with wheel and axle Assembly capable of changing track width during driving mode

(71) Applicant: Chiou-muh Jong, Ellicott City, MD (US)

(72) Inventor: Chiou-muh Jong, Ellicott City, MD (US)

(21) Appl. No.: 14/326,060

(22) Filed: Jul. 8, 2014

(51) Int. Cl. B60B 35/10; B60B 35/00

(52) U.S. Cl. CPC B60B 35/10; B60B 35/003

(57) ABSTRACT

A vehicle having a set of front wheels and axle assembly and a set of rear wheels and axle assembly capable of changing the track width from a wide track to a narrow track or vice versa in vehicle moving condition. The wide track mode is for safe high speed driving and more collision protection from the four wheels. The narrow track is used on the other hand for narrow street and slow speed driving and for easy parking in a narrow space.

### CROSS-REFERENCES TO RELATED APPLICATIONS

Not Applicable.

### BACKGROUND OF THE INVENTION

Small vehicles powered by electricity from batteries or other means offer the solution to city traffic congestion and pollution problem. In fact, very high percentage of vehicles driving on the highway or city streets, especially in the United States, have no more than two occupants. This means that these low occupied vehicles moving on the streets can be replaced by two seat smaller vehicles to lower fuel consumption and lower the pollution level. However, small vehicles typically are not safe to drive on the streets where a lot of big trucks, big SUVs and regular size sedans are also sharing. To make small vehicles safe to drive on the streets, special design for collision prevention should be implemented up to a level that the general public can accept before we see small two seat vehicles widely show up on the streets.

For example, a U.S. patent application US20070164583 presents a design in which vehicle body can be expanded to a bigger size for collision protection during highway driving and shrink back to small size for narrow street driving. The drawback of this design is that, while the vehicle body can be expanded bigger to provide more cushion, the collision protection may not strong enough and it is difficult to make the shell of the vehicle looks appealing.

U.S. Pat. No. 7,780,197 presented a way to extend the front wheels and rear wheels by using telescoping tube structure. The drawbacks of this design is that it still uses a single steering mechanism with rods connecting to both front wheels, thus the complex nature of the mechanism for a heavy farm tractor will be difficult to maintain the rigidity of the structure. The tube axle will also have difficulty to bear the load of the heavy tractor because when it expands outward, the portion left in the frame tube will be very limited because the frame tube needs to contain left and right hand axle tubes, particularly for the rear axle due to the existence of the differential gear. It is easy to see that such expandable axle design is not possible for a small vehicle having a very narrow track such as 42″ to begin with.

Considering that most high speed race cars have a design that typically having a small chassis supported by four wheels which span much wider track width than the width of the chassis, it offers a clue to make a smaller car very stable to drive in high speed and at the mean time it also offers some protection for the chassis from the wider track of four wheels, as well as passengers inside the cars. This idea is particularly useful for developing a small electric vehicle which does not need as much electric power as a traditional vehicles having capacity of four or five passengers. Therefore, it is intuitively true that a design for a small vehicle seating two persons in tandem which is capable of changing its track width to a narrow track for narrow street driving and wide track width for high speed driving would be an ideal small electric car in the near future. A similar design for such purpose is shown, for example, in U.S. Pat. No. 8,746,388. The major disadvantages of design in the above mentioned patent is that it widens the track of front wheels only, not front and rear wheels at the same time and is thus not able to provide as much collision protection and stability as desired. Another disadvantage is that the mechanism to support the track width change, combined with originally equipped suspension and steering mechanism, becomes very complicated and the rigidness of such structure could face big challenge during high speed driving in addition to questionable durability problem.

Electric cars using batteries or fuel cells are gradually considered as a way to solve pollution problem in urban area. However, battery power are still very expensive in terms of reasonable driving range between recharges for a normal five seat sedan. To make electric popular among all drivers, smaller cars with enough collision protection is the way to go; daily commute to work does not need a full sized car.

The purpose of current invention is to provide a set of front wheel and axle assembly and a set of rear wheels and axle assembly for a small vehicle, preferably a electric vehicle with two seats in tandem, such that it can be driven safely with high speed on the highway with expanded track width, yet small enough to tour in narrow streets with retreated narrow track. The no-emission small vehicle is also intended for small parking space, even can be driven into an apartment in a high rise building to save the owner from buying an expensive parking space in big city.

Further more, the intended application of the invention is for electric cars with no emission, small size of such vehicles make them particularly easy to solve parking problem—they don't need to park in conventional parking space. They can even be driven into elevator and parked in the lobby area of a big building, provided that the building is equipped with elevator big enough to carry the vehicle to all levels in the building, thus relieve a lot of city parking problems.

Mention about differential gears for real axles.

### BRIEF SUMMARY OF THE INVENTION

A vehicle with two pairs of wheels associated with a front axle and a rear axle respectively, capable of changing track width during moderate moving speed is disclosed. A control means and an actuator can be used to expand or narrow down the track width to predetermined maximum or minimum widths for different driving environment.

Maximum track width condition offers extra collision protection to the chassis and passengers. It also provides additional driving stability by changing wider track width, as normally the cases in Formula 1 racing cars. Minimum track offers the agility for driving in small lanes with speed limits lower than, say, 50 miles per hour or so.

The car is preferably a small one with electric power and two seats in tandem. Such car consume less power, consequently is the solution to most environmental issues and urban congestion problems exist especially in big cities around the world.

It is therefore a primary object of current invention to provide a small two seat vehicle, electric power preferably, to be able to safely drive on the highways along with other bigger vehicles.

Another object of the present invention is to provide a small vehicle which can be driven to narrow downtown alleys with easiness and smaller parking space.

Another object of the present invention is to promote popularity of small electric power cars while the battery capacity is still too expensive for regular automobiles.

Still another object of the present invention is to make the small electric cars popular for big urban areas where the traffic condition and air quality do not allow more regular automobiles with traditional gas power engines.

Yet another object of the present invention is to provide a more affordable, more economical way to commute for most drivers of single occupant vehicles.

A further object for the present invention is provide small vehicles relieve the parking problems for shopping centers.

Theses and other objects of the present invention will become clearer to those skilled in the art as the description proceeds.

### BRIEF DESCRIPTION OF SEVERAL VIEWS OF THE DRAWING

FIG. 1A and FIG. 1B show the same vehicle in maximum and minimum track width respectively. In FIG. 2A, the front wheel and axle assembly for the same vehicle is shown with wheels 201 and 213 steered to an angle to forward direction.

In FIG. 2A, front axle includes parts 203, 204 and 205, wherein 204 and 205 are axially movable relative to front master axle 203, which is fixed to the car frame with suspension mechanism 210 and 214. The two end plates 206 and 215 are pushed outward and inward when the hydraulic cylinder 209 is actuated to expand or retreat its two rods 208 and 216. Wheels 201 and 213 are turned to slightly of forward direction respectively by their linkages 207 and 217. Inside the two wheels, two sub-assemblies 202 and 218 are shown, which are components for braking and ball joint to enable the turning function of the two front wheels. The coil shape hydraulic tube 212, which is extendable and retractable, is used to provide hydraulic liquid for the power needed in the brake system. In case no hydraulic power is needed, parts 212 can be just a coiled wire supplying electric power to the components in wheel assembly.

The same front axle is also shown in FIG. 2B in narrow track condition. The coil shape hydraulic tube 212 is shown in here squeezed to shorter and more compact shape. In addition, FIG. 2B also shows suspension components 210 and 214.

In FIG. 2C, the rear axle for the same vehicle is shown. Rear wheels 219 and 220 provide propulsion for the vehicle. This axle has the same function to change the width of the track as front axle. FIG. 2D shows the cross section view of the axle in which cylinders 203, 204 and 205 coaxially assembled, with pin 211 functioning to lock all three cylinders from relative rotational movement.

FIG. 3 dictates the second design of wheel-axle assembly of vehicle 300 for variable track width, wherein component numbers appended with letter w represent the vehicle is in wide track condition and n, on the other hand, represent same components are in narrow track condition. For example, wheels 301, 302, 303 and 304 are in wide track 301w, 302w, 303w and 304w position and can move to 301n, 302n, 303n and 304n narrow track positions once the vehicle begins to extract track width. The vehicle has a frame comprising central support beam 305 with its two end structure 308 and 316. Parts 308 and 316 each contains two set of circular sector components such as 306, 309, and 314 at w and n position respectively and circular track such as 309t and 313t. Front bendable axle contains left arm 310, right arm 315, rear bendable axle left arm 317 at w and n position respectively. Each front wheel also has steering linkage such as 307 at position w or n. The motor driven rack and pinion assembly 313 is used to pull or push four sets of racks such as parts 312 to wide or narrow track positions. In the process of widening or narrowing, the four circumferential sector groove such as 313t are used to guide moving axle arm 310 which include a guiding cylinder slider 311 to move to from wide position w to narrow n.

Left arm 317, wheel disk 319, link bar 318 and frame 305 form four bar parallel mechanism, hinged at 324w, 320w, 321 and 322 respectively.

The detailed structure of wheel assembly is further shown for parts 303 at n position, where 303n1 is the wheel to be attached to parts 303n2 with 303n3 inserting into the tunnel center hole of 303n1. 303n2 and parts 303n9 form are engaged by the ball joint 303n4 allowing the wheel to be steered by the linkage 303n8 driven by motor operated gear mechanism 303n7. Four bar linkage bars 323n and 315n also connected and hinged to 303n6.

From FIG. 4A to FIG. 4E, a sequence of operations to change the track width is illustrated. FIG. 4F shows the detailed structure of a rear wheel assembly which enables the motor driven worm gear 401 to change the angle of rear wheel relative to forward direction by imposing linear rotational movements of 402. The assembly attached to rear axle 405 also includes a parts 404 with uneven channel to allow oscillation of the wheel axis hinged at 403.

### DETAILED DESCRIPTION OF THE INVENTION

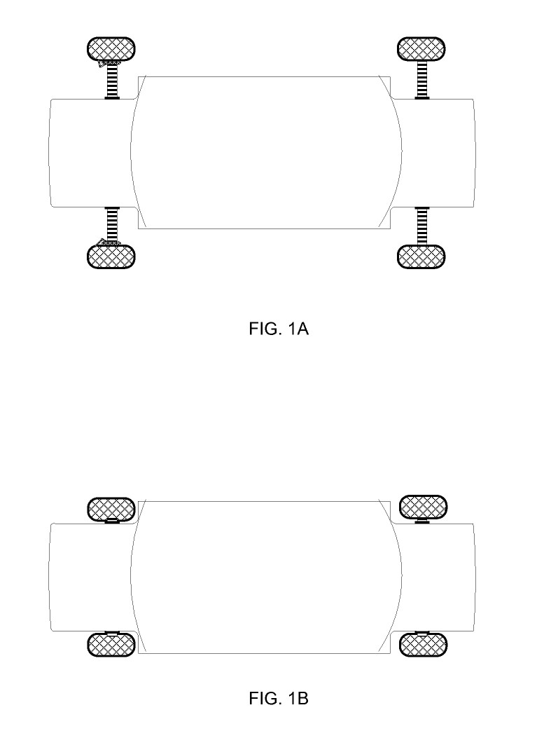

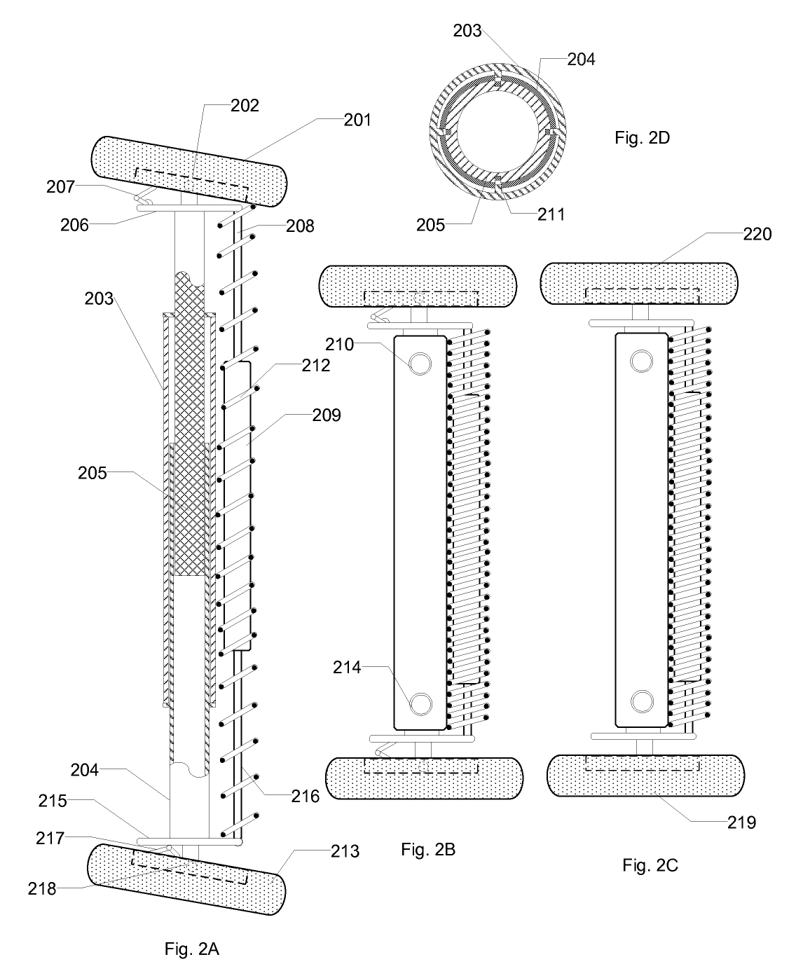

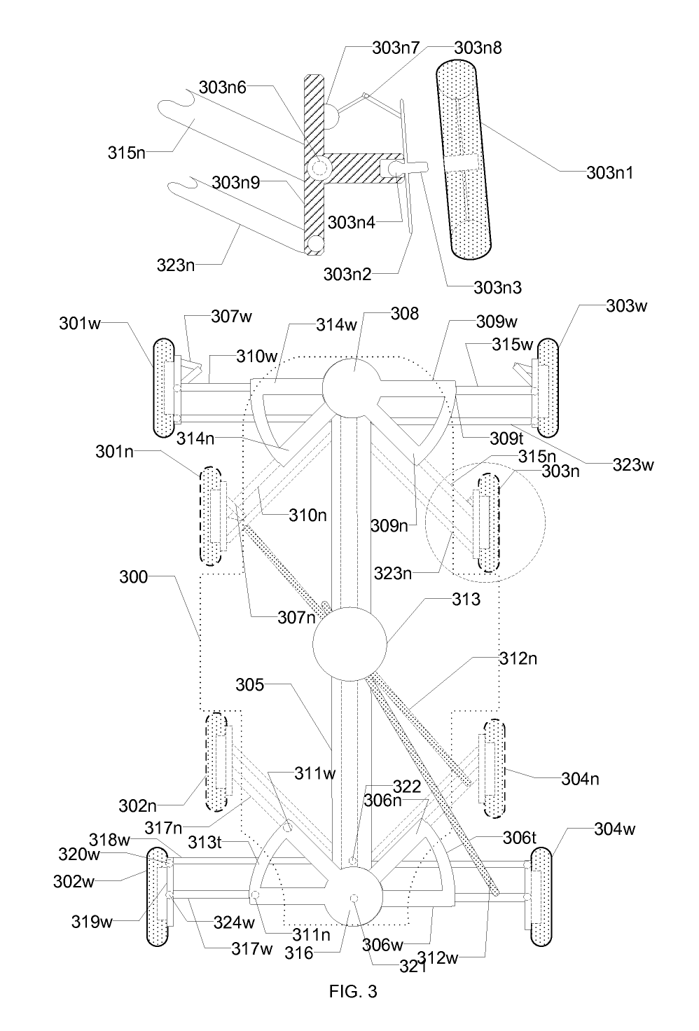

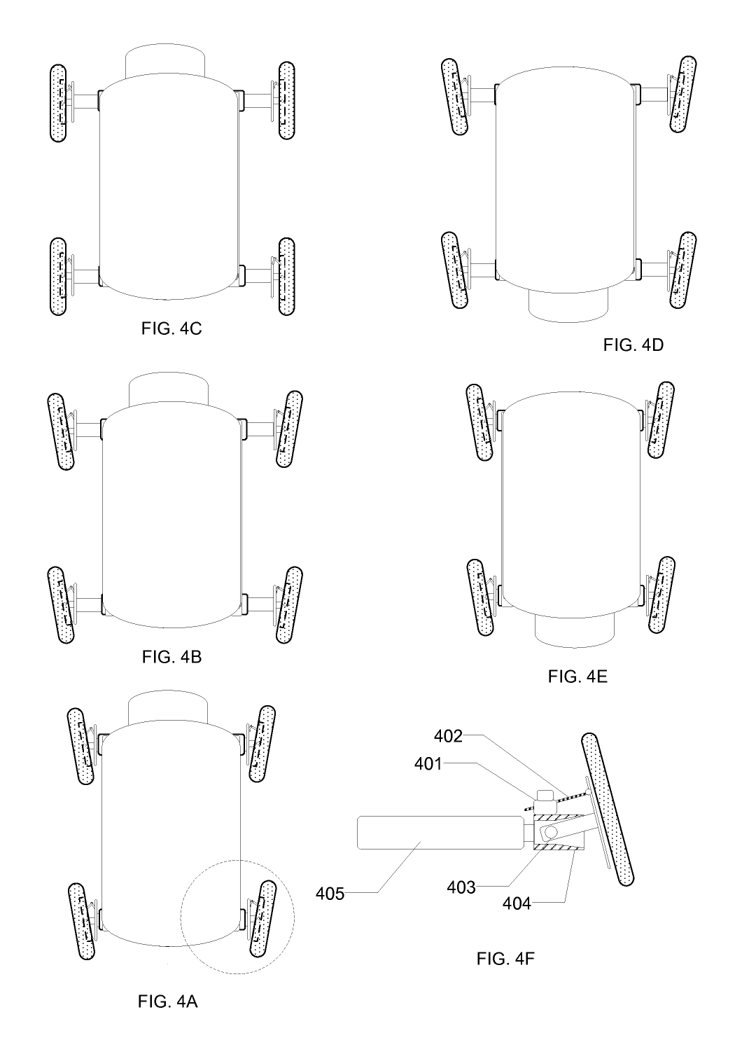

FIG. 1A and FIG. 1B show the two operation modes of a vehicle according to the invention. Wide track mode as shown in FIG. 1A for vehicle traveling at high speed, typically higher then 50 miles per hour. FIG. 1B, on the other hand, shows the narrow track mode intended for traveling at low speed as typically in small streets, alleys and lane where normal sedans are not easy to get in and where chassis protection is not as important.

The implementation of current invention is to design a low energy consumption small vehicle, particularly an electric power one, which can expand its four wheels to a wider track width, consequently occupy bigger strip of the road than the width of its unchanged chassis in order to avoid the chassis being directly collided when it is driven on interstate highway along with many other much bigger vehicles at speed higher than 60 miles per hour. An ideal design will be to have a wide track width wider than 60″. 62″, for example, is roughly about the same as most compact vehicles traveling on the highway. Taking 62″ as the target wide track width, a narrow track width to match would be reasonably around 36″, which is about the width of most golf carts which seat two people in parallel. However, considering the vehicle implemented under current invention is to travel at speed much higher than golf carts even at narrow track mode, the narrow track width should be a little wider, say, 42″ is more appropriate. Such vehicle would be best designed in style of tandem seating for two person such that each of them will have plenty of space to operate the vehicle or seating behind doing other things. In such proposed design, the track width will expand 10″ each side for a total width expansion of 20″, which will significantly increase ability to prevent the vehicle from tip over in addition to be able to avoid the chassis being collided by other vehicles.

First implementation of the invention is shown in FIG. 2A, FIG. 2B and FIG. 2C. FIG. 2A in particular, shows the front axle and front wheel assembly, with the wheels 201 and 213 being turned slightly off parallel direction to illustrate the front wheel steering. In conventional vehicles, a rack and pinion assembly driven by the steering wheel and mostly assisted by hydraulic system is used to connect and steer the front wheels, which makes the design of a front axle-wheel assembly capable of dynamically changing track width a difficult, if not impossible thing to consider. Similarly, the need of a differential gear box at the center of rear axle also makes the idea of changing track width for a rear axle-wheel assembly run into similar degree of difficulty. By contrast, current invention eliminates the need of a rigid connecting rod by using motor driven linkage in each of the two front wheels and control both motors by wires, such arrangement make the front axle-wheel assembly capable of dynamic movements of inward and outward in driving condition much easier to design. For rear axle-wheel assembly, similar task will be easier by using motor wheels to eliminate the need of differential gear box. However, in one implementation of current invention, it still possible to use differential gear box for rear axle as will be discussed later paragraph.

In FIG. 2A, a frame cylinder 203 rigidly connected to vehicle frame by 210 and 214 in FIG. 2B. Frame cylinder 203 hosts cylinder 204 and cylinder 205 coaxially, allowing relative axial movement such that each of 204 and 205 can move outward to a position corresponding to wide track condition and can retract back to position indicated as in FIG. 2B as narrow track condition. The pin 211 shown in FIG. 2D is used to prevent all relative rotational movements between 203 and 204 and between 204 and 205 to make the turning of front wheels 201 and 213 free from front axle. In order to support the weight of the vehicle, parts 204 and 205 should have substantial portion left in 203 when they expand to the maximum in the wide track condition. This means that under the narrow track condition, each of parts 204 and 205 should have a length extend to whole frame cylinder. In real design, the vehicle may have a narrow track width of 42″, which implies that frame cylinder will have a length of roughly 32″ if the half of tire width and a clearance of at least 2″ is needed for steering component to operate. This further implies that the lengths of parts 204 and 205 inside the frame cylinder 203 will be around 30″. If we are designing a vehicle to have 20″ between wide track and narrow track widths, 204 and 205 will each moves outward 10″ to have an wide track width of 62″, which is roughly close to the track width of a compact car, the portion of 204 and 205 left inside 203 will be still a substantial length of 20″ for supporting the vehicle weight.

Theoretically, it would be ideal and much simpler to use a double end cylinder in stead of parts 203, 204 and 205 to push or retract the wheels between w and n position. However, hydraulic cylinders are not built to bear forces across its axial direction. In addition, there would be not enough space for the cylinder rods to expand or retract 10″ or more with enough portion to support the weight of the vehicle as analyzed earlier. However, it is possible to design an front axle having two hydraulic cylinders capable of bearing load across cylinder axis. The two cylinders will optimally be part of the vehicle frame and horizontally parallel to each other, and overlap each other as much as possible to support the vehicle weight as mentioned in previous paragraph.

The two front wheels have motor driven linkages 207 and 217 to steer the wheels for driving direction. The synchronism of the steering to these two wheels can be achieved by firmware or software which controls the motors in the parts 207 and 217. Inside the wheels, pivots 202 and 218 respectively are used support the turning from steering action.

FIG. 2C shows a rear axle which attaches motor wheels 219 and 220 for propulsion. The advantage of using motor wheel is to eliminate as many mechanical components as possible, here the elimination of differential gear box is a clear example that its function can be replaced by software control to the motor wheel speed to achieve that differential effect. The motor wheels can also include regeneration system to work as brake system and recover brake energy as electricity and send it back to battery. Without differential gear box, the rear axle can be designed to be exactly like the front axle mentioned above.

To switch from narrow track to wide track or vice versa, there are two ways to achieve that. We can add a hydraulic cylinder with double ends such as parts 209 and its two rods 208 and 216 to expand and retract the wheels to achieve the switches. Or we can use the vehicle momentum directly to achieve same goal.

Since the forces needed to push wheels outward and retract them inward are in axial direction and are orthogonal to the direction of propulsion, special arrangements are needed to create such axial forces to achieve the goal. Intuitively, a hydraulic cylinder which is capable of pushing both ends is clearly a solution, and such parts is shown as hydraulic cylinder 209 in FIG. 2A, which pushes and retracts the rods 208 and 216. The hydraulic fluid can also be supplied using the coil tube 212 for brake systems in front wheels if needed; otherwise the coil tube can be coil power cable to provide electricity for the motor driven steering linkage 207 and 217.

Apparently, using hydraulic cylinders such as parts 209 is not the only way to expand or retract the track width of wheels. Linear motion device for this purpose includes using gear-rack assembly to force the expansion and retraction of wheels, as well as using hydraulic cylinder like parts 209 to achieve same function. Both ways are very mature and have their own advantages.

However, a preferred implementation to create the axial force components is to control front and rear wheels such that they can turn to open alignment stance, as shown in FIG. 4A and FIG. 4B and turn to close alignment stance as shown in FIG. 4D and FIG. 4E. Clearly, an open alignment stance in forward moving condition will create a pair of axially outward force components with strength depends on the degree of opening of relative to the vehicle moving direction. Such components can ideally be used to push the front wheels and rear wheels until maximum track width is reached. Similarly, when moving forward a close alignment stance will tend to have the force components created to retract the wheels until the minimum track width is reached.

To create open or close alignment for front wheels, the linkages used to steer the wheels can be used. However, it should be a control independent of steering operation. In steering the two front wheels simultaneously turn to the same side, right or left, with an angle depends on how much the drive steers to turn. The control to open or close alignment make the two front wheel turn to opposite sides with the same angle, and should be designed to operate automatically, not by a manipulating tool such as a steering wheel. Also, the degree of open or close should depend how big the axial force is needed in order to overcome the friction in sliding inside the frame cylinder 303, and the speed of vehicle in operation. This is a factor which can be predetermined during designing and testing phase; as such a control system should be designed to operate wheel opening angle as a function of vehicle speed.

For rear wheels, the open or close alignment stance can be achieved by having the rear wheel designed as shown in FIG. 4F, where motor driven rack and pinion mechanism 401 with rack 402 is installed to change the direction of the rear wheel. The rear axle 405 connects rigidly to a slot 404 which further includes a hinge 403 for allowing the rear wheel to turn freely.

Ideally, a button should be installed in the front panel of a vehicle so that, when pushed, the control system will automatically sense to expand the track width or to retract it, so that it will start to simultaneously open or close the alignments for front and rear wheels such that the expansion or retraction of the track width of the four wheels will be executed until wide or narrow track width is reached, and the control system will automatically restore open or close alignment to normally parallel stance. Since the travelling length of expanding and retracting will be very short, as in a design of 10″ mentioned earlier, it will take only a short time, say, 10 seconds or so to finish the whole procedure of expansion or retraction. Under such scenario, it is expected that such operation is best conducted when driving at slow speed such as 10 to 20 miles per hour and on a straightforward driving condition. However, it should not consider this as a limitation to current invention, because, physically, even if a vehicle is steered to turn a small angle to the right or left, the front wheels still can be set to an open alignment or close stance to create required force components for expanding or retracting the front wheels. Also, it is theoretically same result if we drive backward with open or close alignment stance, except that it is awkward to do such operation in driving backward.

A second way to make four wheels of a vehicle to have variable track width is to have the wheel-axle assembly and vehicle frame as shown in FIG. 3, in which a pair of double sector shape frames are used to guide a front bendable axle and a rear bendable axle to move to straight or bended position and hold there for maximum or minimum track width. Front double sector frame, for example, has two sectors 309 and 314 respectively, for holding right arm of front bendable axle 315 at wide track position w and narrow track position n and similarly for left arm 310 by sector 314. Same structure as front double sector frame but rotated by 180 degree is used for rear axle, where it illustrates that left rear arm 317 of rear bendable axle can be guided by ball or cylinder structure guilder 311 from w to n position or vice versa, guiding inside circular track 313t of the rear double shape frame.

To make sure the four wheels of a vehicle will keep parallel to the center line defined by vehicle frame 305 while the axles moving from w to n or from n to w position, a parallel four bar linkage is applied to all four wheels and all of the four linkages naturally include portion of vehicle frame 305 as one of their four bars. The left rear wheel, for example, is guided by the four bar linkage constituted by the arm 317 of rear axle, wheel disk 319, bar 318 and portion of frame 305. The four joint points for the four bar are also show in FIG. 3 at joints 324, 320, 322 and 321, where joint 321 is also the joint for the two arms of the rear bendable axle. Similarly, right arm 315 of the front bendable axle and bar 323 are the two bars of a four bar linkage for right wheel of the front bendable axle, and are illustrated more in later paragraph.

Now again the forces needed to move four wheels from w to n position or vice versa can come from two sources, say, from an external motor driven mechanism 313 with a rack 312 as shown in FIG. 3, or from the momentum readily available from vehicle propulsion. In the case of using an external motor driven mechanism, parts 313 is an assembly of 4 pinions which share one shaft driven by a motor such that, when in operation, will simultaneously pull or push four racks such as parts 312 so that all four arms, two of front axle and another two of rear axle will move to w or n position at the same time. The control of mechanism 313 is pretty straightforward; a button on the front panel can be used to drive the motor clockwise or counterclockwise to achieve the goal. Some limit switches can be used to sense the exact position of maximum and minimum positions as well as current position is needed for the control to set clockwise or counterclockwise rotation.

While mechanism 313 is used to integrally pull or push the four arm as a unit, many other designs are still possible. For example, 313 can be designed to have two separated units, one for front arms and the other for rear arms. Hydraulic cylinders can also be used instead of the rack and pinion mechanisms.

To explain more details about front wheel operation during the movement of bendable axle and front wheel, one of the two front wheel 303 at n position is used for further illustration. Wheel 303n1 is mounted with screws on parts 303n2 as 303n3 penetrates into the center tunnel hole of the wheel. The wheel 303n1 is then can freely turn, pivoting the ball joint 303n4 such that linkage 303n8, controlled by the motor driven oscillating mechanism 303n7, which is operated integrally with the counter parts of another front wheel, serves as the steering mechanism for the vehicle. The right arm of front axle 315n1, connects to wheel shaft 303n9 by a hinge 303n6, makes the bendable right arm 315n1 rotatable under the constraint of four bar linkage which includes portion of 303n9, 323n, 315n and portion of frame 305 to assure 303n9 always keep parallel to body frame 305 when arm 315 move from w to n or from to w position.

When the momentum or momentum change of a the vehicle is considered, the mechanism such as 313 and its four racks become unnecessary. Instead, a control procedure can be set to automatically execute to move the four wheels to w or n position in vehicle moving condition. For example, if the front wheels are partially braked while the propulsion of rear two wheels is on, the vehicle tend to move faster than the front wheels, consequently exerting a reaction force at each front wheel and force its bendable arm to move backward, causing the front wheels move from w to n position. At the mean time, due to the braking action of the front wheels, the vehicle will move slower than it should from the propulsion, resulting a net force at each rear wheel to move ahead of the vehicle, consequently the two rear arms gradually move and engage into n position. Therefore, the action of partially braking front wheels while acceleration pedal is being depressed, the bendable axles will automatically move from w to n position.

We see that, for a rear wheel drive vehicle, forward moving momentum of the vehicle can easily be taken advantages for switching the vehicle from w to n position, given the vehicle design as depicted in FIG. 3, by a very simple action of braking front wheels while accelerating. Unfortunately, it will be a much more difficult situation to bring the vehicle from n position to w position for same rear drive vehicle. This is because the lack of propulsion from front wheels makes us unable to do the similar trick by braking rear wheels and hope that the two axles will move from n to w position. More specifically, if the rear wheels of such forward moving vehicle are braking partially, the big momentum will be more than enough to force the two rear wheel move to the w position, but it is difficult for the front wheels to move into w position because the relatively small momentum of the two wheels may not enough to overcome the friction force incurred by the weight of the vehicle to the circular track of the sector, unless the vehicle is moving very fast, so fast that front wheels can overcome the friction and move forward to the w position. Since the operation of changing track width is not encouraged in a vehicle moving too fast, a different approach should be taken. A remedy for this would be to apply the method of open alignment stance to the front wheels mentioned earlier so that a pair of axial forces will be created to help front wheels move to the w position. Fortunately, this remedy is easy to apply since it is for the front wheels, of which steering linkages and motor control mechanism such as parts 303n8 and 303n7 already exist to steer the wheels. This means that only a separate software control is needed to implement this remedy and is exactly the same as previous implementation mentioned in FIG. 4F. Of course, it would not be a problem for a four wheel drive vehicle as mentioned earlier. Also, driving backward would solve the problem, but again it is awkward to do such operation in driving backward and is more dangerous to do so.

To compare the two implementations depicted in FIGS. A-C and FIG. 3, it is seen that the two implementations change the aspect ratio of wheelbase to track width with very different result. The first implementation results a wider track width without changing the length of wheelbase, while the second implementation changes both the length of wheelbase and track width in such a way that the aspect ratio remains almost constant. Considering a typical automobile such as the Year 2014 C class of Mercedes brand has an 1.8 aspect ratio and this value of 1.8 is pretty much the approximate values for all other models and brands, this value can be used as a reference for the two implementations under current invention. In the first implementation, it may be good to use a value of slightly over, say, 1.9 for narrow track of 42″ which corresponds to a wheelbase of 80″ and becomes 1.29 when the wheel track expands to 62″. Such design is still very reasonable for a small car having a tandem seat capacity of two persons because it still offer enough space to have comfortable two seats in between two axles and the low value of aspect ratio of 1.29 at wide track will not cause any safety concern. The second implementation depicted in FIG. 3, on the other hand, can use 1.8 as the aspect ratio, which would lead to a wheelbase of 76″, and the aspect ratio changes to a slightly higher 1.96 at wide track, while its wheelbase also lengthened to 122″, which is even better from the standpoint of using the four wheels as a shield to protect vehicle chassis. Therefore, each implementation in vehicle structure design mentioned above under current invention has its own advantages.

Although the predetermined wide track and narrow track are different for front axle and rear axle in the setting of current invention, there is no reason they can not be the same.

The embodiments presented above are typical embodiments of current invention. Various modifications can be made without departing from the scope of the invention, which is defined by the attached claims. For example, one of the double sector shapes structure may be turned 180 degrees and still can serve to expand and retract the track width. The vehicle may also comprise more than two axles.

I claim:

1. A vehicle comprising:
a front axle with a pair of front wheels having a track width adjustable between a predetermined front wide track and a predetermined front narrow track,
a rear axle with a pair of rear wheels having a track width adjustable between a predetermined rear wide track and a predetermined rear narrow track and a control means for synchronously turning said pair of front wheels and said pair of rear wheels in driving mode from driving direction to an open alignment stance for creating axially outward forces, which exert on said pair of front wheels to expand from said predetermined front narrow track to said predetermined front wide track and exert on said pair of rear wheels to expand from said predetermined rear narrow track to said predetermined rear wide track, and for synchronously turning said pair of front wheels and said pair of rear wheels in driving mode from driving direction to an close alignment stance for creating axially inward forces, which exert on said pair of front wheels to retract from said predetermined front wide track to said predetermined front narrow track and exert on said pair of rear wheels to retract from said predetermined rear wide track to said predetermined rear narrow track, whereby said vehicle can be operated continuously from narrow track mode to wide track mode and from wide track mode to narrow track mode in vehicle moving condition.

2. The vehicle according to claim 1, wherein each of said pair of front wheels further comprising a motor driven gear mechanism with a linkage and wherein said vehicle further comprising a control means to steer said pair of front wheels synchronously for a driving direction.

3. The vehicle according to claim 1, wherein each of said pair of front wheels and each of said pair of rear further comprising a brake mechanism and wherein said vehicle further comprising a control means to synchronously brake said pair of front wheels and said pair of rear wheels for bringing said vehicle to stop.

4. The vehicle according to claim 1, wherein each of said pair of rear wheels is a motor wheel assembly further comprising an electric motor for propulsion of said vehicle and wherein further comprising a software control means for controlling each said electric motor to achieve differential gear function for said pair of rear wheels.

5. A method for changing the track width of a vehicle in driving mode comprising the steps of:
providing a front axle with a pair of front wheels having a track width adjustable between a predetermined front wide track and a predetermined front narrow track,
providing a rear axle with a pair of rear wheels having a track width adjustable between a predetermined rear wide track and a predetermined rear narrow track,
turning synchronously said pair of front wheels and said pair of rear wheels in driving mode from driving direction to an open alignment stance for creating axially outward forces, which exert on said pair of front wheels to expand from said predetermined front narrow track to said predetermined front wide track and exert on said pair of rear wheels to expand from said predetermined rear narrow track to said predetermined rear wide track,
turning synchronously said pair of front wheels and said pair of rear wheels in driving mode from driving direction to an close alignment stance for creating axially inward forces, which exert on said pair of front wheels to retract from said predetermined front wide track to said predetermined front narrow track and exert on said pair of rear wheels to retract from said predetermined rear wide track to said predetermined rear narrow track, whereby a vehicle by said method can be operated continuously from narrow track mode to wide track mode and from wide track mode to narrow track mode in vehicle moving condition.

6. The method according to claim 1, wherein each of said pair of front wheels further comprising a motor driven gear mechanism with a linkage and wherein said vehicle further comprising a control means to steer said pair of front wheels synchronously for a driving direction.

7. The method according to claim 1, wherein each of said pair of front wheels and each of said pair of rear further comprising a brake mechanism and wherein said vehicle further comprising a control means to synchronously brake said pair of front wheels and said pair of rear wheels for bringing said vehicle to stop.

8. The method according to claim 1, wherein each of said pair of rear wheels is a motor wheel assembly further comprising an electric motor for propulsion of said vehicle and wherein further comprising a software control means for controlling each said electric motor to achieve differential gear function for said pair of rear wheels.

9. A vehicle comprising:
a front axle with a pair of front wheels having a track width adjustable between a predetermined front wide track and a predetermined front narrow track,
a rear axle with a pair of rear wheels having a track width adjustable between a predetermined rear wide track and a predetermined rear narrow track,
a front linear motion device for synchronously pushing each of said pair of front wheels outward to said predetermined front wide track and for synchronously retracting each of said pair of front wheels to said predetermined front narrow track,
a rear linear motion device for synchronously pushing each of said pair of rear wheels outward to said predetermined rear wide track and for synchronously retracting each said pair of rear wheels inward to said predetermined rear narrow track and
a control means for systematically controlling said front linear motion device and said rear linear motion device for the actions of pushing and retracting, whereby said vehicle can be operated continuously from narrow track mode to wide track mode and from wide track mode to narrow track mode in vehicle moving condition.

10. The vehicle according to claim 9, wherein each of said pair of front wheels further comprising a motor driven gear mechanism with a linkage and wherein said vehicle further comprising a control means to steer said pair of front wheels synchronously for a driving direction.

11. The vehicle according to claim 9, wherein each of said pair of front wheels and each of said pair of rear further comprising a brake mechanism and wherein said vehicle further comprising a control means to synchronously brake said pair of front wheels and said pair of rear wheels for bringing said vehicle to stop.

12. The vehicle according to claim 9, wherein each of said pair of rear wheels is a motor wheel assembly further comprising an electric motor for propulsion of said vehicle and wherein further comprising a software control means for controlling each said electric motor to achieve differential gear function for said pair of rear wheels.

13. A vehicle comprising:
A front bendable axle with a pair of front wheels having a track width adjustable between a predetermined front wide track and a predetermined front narrow track,
a rear bendable axle with a pair of rear wheels having a track width adjustable between said predetermined rear wide track and said predetermined rear narrow track,
a center vehicle frame with a front hinge at front end thereof said front bendable axle pivoting for bending movement and a rear hinge at rear end thereof said rear bendable axle pivoting for bending movement,
a double sector shape frame with a center disk structure secured to said front hinge for holding said front bendable axle to straight position thereby setting said pair of front wheels at said predetermined front wide track position, and holding said front bendable axle at bended position thereby setting said pair of front wheels are said predetermined front narrow track position,
a double sector shape frame with a center disk structure secured to said rear hinge for holding said rear bendable axle to straight position thereby setting said pair of rear wheels at said predetermined rear wide track position, and holding said rear bendable axle at bended position thereby setting said pair of rear wheels are said predetermined rear narrow track position and
a control means for selecting a sequence of actions in vehicle moving mode from a plurality of actions comprising partial braking of said pair of front wheels, partial braking of said pair of rear wheels, adjusting to open alignment of said front wheels, adjusting to close alignment of said front wheels, adjusting to open alignment of said rear wheels, adjusting to close alignment of said rear wheels and adjusting of propulsion output, thereby creating outward push to set said front bendable axle at said predetermined front wide track and said rear bendable in straightened position for said predetermined rear wide track and creating inward pull to set said front bendable axle at said predetermined front narrow track and said rear bendable in bended position at said predetermined rear narrow track,
whereby said vehicle can be operated continuously from narrow track mode to wide track mode and from wide track mode to narrow track mode in vehicle moving condition.

14. The vehicle according to claim 13, wherein each of said pair of front wheels further comprising a motor driven gear mechanism with a linkage and wherein said vehicle further comprising a control means to steer said pair of front wheels synchronously for a driving direction.

15. The vehicle according to claim 13, wherein each of said pair of front wheels and each of said pair of rear further comprising a brake mechanism and wherein said vehicle further comprising a control means to synchronously brake said pair of front wheels and said pair of rear wheels for bringing said vehicle to stop.

16. A vehicle comprising:
A front bendable axle with a pair of front wheels having a track width adjustable between a predetermined front wide track and a predetermined front narrow track,
a rear bendable axle with a pair of rear wheels having a track width adjustable between said predetermined rear wide track and said predetermined rear narrow track,
a center vehicle frame with a front hinge at one end thereof pivoting said front bendable axle for bending movement and a rear hinge at another end thereof pivoting said rear bendable axle for bending movement,
a double sector shape frame with a center disk structure secured to said front hinge for holding said front bendable axle to straight position thereby setting said pair of front wheels at said predetermined front wide track position, and holding said front bendable axle at bended position thereby setting said pair of front wheels at said predetermined front narrow track position,
a double sector shape frame with a center disk structure secured to said rear hinge for holding said rear bendable axle to straight position thereby setting said pair of rear wheels at said predetermined rear wide track position, and holding said rear bendable axle at bended position thereby setting said pair of rear wheels are said predetermined rear narrow track position,
two sets of front linear motion devices, each connecting to left arm and right arm of said front bendable axle respectively, for pulling to bend and pushing to straighten said front bendable axle respectively,
two sets of rear linear motion devices, each connecting to left arm and right arm of said rear bendable axle respectively, for pulling to bend and pushing to straighten said rear bendable axle, and
a power driven control means for synchronously operating said front linear motion devices and said rear linear motion devices, whereby said vehicle can be operated continuously from narrow track mode to wide track mode and from wide track mode to narrow track mode in vehicle moving condition.

17. The vehicle according to claim 16, wherein each of said pair of front wheels further comprising a motor driven gear mechanism with a linkage and wherein said vehicle further comprising a control means to steer said pair of front wheels synchronously for a driving direction.

18. The vehicle according to claim 16, wherein each of said pair of front wheels and each of said pair of rear further comprising a brake mechanism and wherein said vehicle further comprising a control means to synchronously brake said pair of front wheels and said pair of rear wheels for bringing said vehicle to stop.
